(19) United States
(12) Patent Application Publication
(10) Pub. No.: US 2026/0006490 A1
(43) Pub. Date: Jan. 1, 2026

(54) RESOURCE-SAVING MODE FOR TRANSMISSION OF PDU SETS

(71) Applicant: APPLE INC., Cupertino, CA (US)

(72) Inventors: Ping-Heng Kuo, London (GB); Fangli Xu, Beijing (CN); Ralf Rossbach, Munich (DE)

(21) Appl. No.: 18/880,795

(22) PCT Filed: Aug. 3, 2022
(86) PCT No.: PCT/CN2022/110061

§ 371 Date: Jan. 2, 2025

(51) Int. Cl. H04W 28/06; H04L 47/28; H04L 47/32; H04W 28/02

(52) U.S. Cl. CPC H04W 28/06; H04L 47/28; H04L 47/32; H04W 28/0268

(57) ABSTRACT

A wireless device is configured to transmit a protocol data unit (PDU) set. The wireless devices receives a configuration of a resource-saving mode in which the wireless device is allowed to discard, when a minimum requirement for delivering the PDU set is satisfied, one or more packets of the PDU set. The wireless device determines information to evaluate the minimum requirement for delivering the PDU set and processes the PDU set for transmission, When the minimum requirement for delivering the PDU set is satisfied, based on the information, the wireless device determines that the PDU set is successfully delivered and discards any unsent packets of the PDU set.

### TECHNICAL FIELD

This application relates generally to wireless communication systems, including wireless communication systems with extended reality (XR) downlink and uplink communications.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates example PDU sets that may be used in XR communications in certain embodiments.

FIG. 2 is a flow diagram of a method for a transmitting device in a resource-saving mode for transmission of a PDU set according to one embodiment.

FIG. 3 is a flow diagram of a method for a transmitting device in a resource-saving mode for transmission of a PDU set according to another embodiment.

FIG. 4 illustrates an example architecture of a wireless communication system, according to embodiments disclosed herein.

FIG. 5 illustrates a system for performing signaling between a wireless device and a network device, according to embodiments disclosed herein.

FIG. 6 illustrates an example service based architecture in accordance with certain embodiments.

FIG. 7A illustrates an example of a user plane protocol stack in accordance with one embodiment.

FIG. 7B illustrates an example of a control plane protocol stack in accordance with one embodiment.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

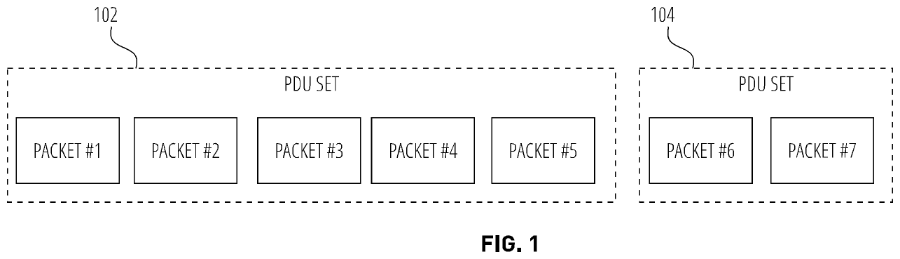

Extended reality (XR) applications may include, for example, virtual reality (VR), mixed reality (MR), and/or augmented reality (AR) downlink and uplink communications. XR services can operate on a protocol data unit (PDU) set, which includes multiple internet protocol (IP) packets or PDUs. For example, FIG. 1 illustrates example PDU sets that may be used in XR communications in certain embodiments. A first PDU set 102 includes a plurality of IP packets (shown as Packet #1, Packet #2, Packet #3, Packet #4, and Packet #5). A second PDU set 104 includes a plurality of IP packets (shown as Packet #6 and Packet #7). Skilled persons will recognize from the disclosure herein that the first PDU set 102 and/or the second PDU set 104 may comprise more or fewer IP packets (or PDUs) and that XR traffic may use any number of PDU sets.

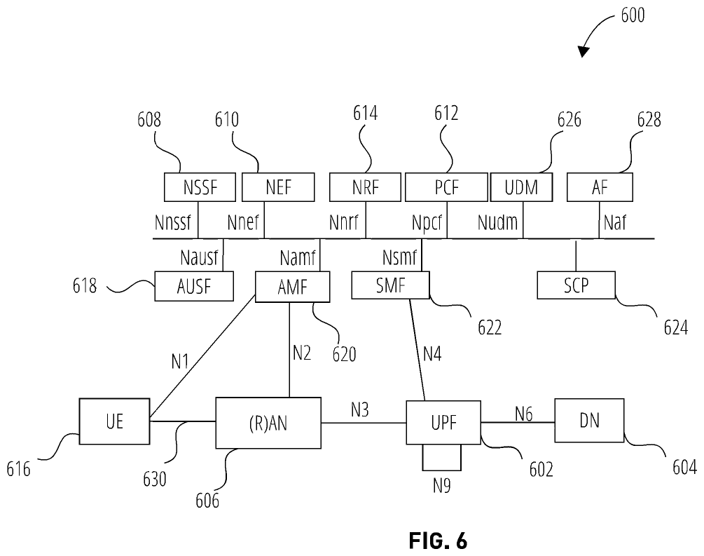

A user plane function (UPF) (e.g., UPF 602 shown in FIG. 6), may identify a PDU set based on PDU set sequence number (SN), start/end PDU of the PDU set, PDU SN within a PDU set, or the number of PDUs within a PDU set. The UPF also provides the information relating to PDU sets to the RAN. Such information may include, for example, quality of service (QOS) flow information.

PDU sets may be mapped to different QoS flows. The QoS flow may be identified using a QoS flow identifier (ID) and each PDU set within the QoS slow may be identified using a PDU set SN. Each QoS flow can be used to deliver one or more PDU set. New QoS parameters for PDU sets based QoS handling may be defined in a 5G system (5GS), such as PDU set delay budget (PSDB), PDU set error rate (PSER), a parameter to indicate whether to drop a PDU set in case the PSDB is exceeded, a parameter to indicate whether all PDUs within a PDU set are needed for the usage of the PDU set by the application layer, and/or a PDU set priority.

In certain wireless systems, a QoS parameter for a PDU set may indicate whether all PDUs within the set are needed for the use of the PDU set by the application layer. For example, in some cases, it is possible that an XR application can still make use of a PDU set without using all of the PDUs in the PDU set (although maybe not optimally). The XR application may only need a minimum number of packets (or at least one essential packet) in a PDU set as a bottom line. A particular application may indicate that one or more packets are essential or more useful than other packets within a PDU set. In FIG. 1, for example, an application may indicate that Packet #1 and Packet #2 are more essential than Packet #3, Packet #4, and Packet #5. In other words, the application may achieve a particular result using only Packet #1 and Packet #2, while also using Packet #3, Packet #4, and Packet #5 may achieve a more optimal result.

Thus, from a resource efficiency point of view, the RAN may have some leeway to save resources (e.g., when the RAN is overloaded). When one or more PDUs in a PDU set can be discarded, certain embodiments disclosed herein provide a mode of PDU set transmission that can be used to save resources. In other words, when the application layer does not need all packets of a PDU set for a particular result, methods and apparatus are provided to achieve better resource efficiency for PDU set transmission.

In certain embodiments, a transmitting device (e.g., a UE or a base station) of PDU sets does not attempt to transmit all the packets of a PDU set. Rather, the transmitting device considers a PDU set as successfully delivered when a minimum requirement of the application is met. The transmitting device the proactively discards the remaining packets of the PDU set in the transmit buffer.

The transmitting device of PDU sets may be configured to operate in a resource-saving mode to transmit the PDU sets. In one embodiment, the resource-saving mode is configured per data radio bearer (DRB). For example, a UE applies the resource-saving mode only for transmissions on one or more DRBs that are so configured. In another embodiment, the resource-saving mode is configured per QoS flow. For example, a UE applies the resource-saving mode only for transmissions associated with one or more Qos flows that are so configured.

When transmitting a PDU set corresponding to a DRB or a QoS flow configured with the resource-saving mode, the transmitting device evaluates if the status of the PDU set already meets one or more conditions. Based on the evaluation, the UE determines if the packets of the PDU set that are still pending in the buffer should be discarded. The conditions may include at least one of the following: at least M packets of the PDU set are already successfully transmitted (where M is an integer value); at least M packets of the PDU set are submitted to the lower layer; the essential packets of the PDU set are already successfully transmitted; the essential packets of the PDU set are submitted to the lower layer; the elapsed time since the arrival of the first packet of the PDU set has reached a threshold (e.g., this condition may be controlled by a timer); and/or the remaining time until the expiry of the PDU set delay budget (PSDB) is lower than a threshold.

In some embodiments, the transmitting device does not check to determine whether the conditions are met for every PDU in the PDU set. For example, it can be up to implementation to determine when or how often the transmitting device carriers out such checking.

To evaluate whether the condition is met, the transmitting device may need some additional information including, for example, the value of M and/or the identification of the essential packets. The value of M is a minimum number of packets required by the application in order to use the corresponding PDU set. In one embodiment, the value of M is directly provided by a network node (e.g. core network or gNB). In another embodiment, the value of M is derived by the transmitting device itself based on information such as the percentage of a PDU set that is to be successfully delivered (which can be provided by the network node). The value of M may be varied for different PDU sets. In some cases, the value of M may be zero, wherein the transmitting device may determine to drop the PDU set directly without transmitting any of its packets when operating in the resource-saving mode.

Some PDU sets may comprise one or more packets that are more essential than the other packets in the same PDU set. The transmitting device may be able to identify which packets in a PDU set are essential based on the information provided by a network node (e.g. core network or gNB). In certain embodiments, the identification of essential packets may be up to implementation, wherein configuration information may not be needed.

In certain embodiments, some PDU sets may have no essential packets (i.e. none of the packets in a PDU set is considered as an essential packet). In this case, when operating in the resource-saving mode, the transmitting device may determine to directly drop the PDU set without transmitting any of its packets.

In one embodiment, the transmitting device may be configured with a counter, which counts how many packets of a PDU set are delivered. When the counting reaches the value of M, the transmitting device may discard the remaining packets of the current PDU set and reset the counter for a subsequent PDU set.

In one embodiment, the transmitting device may be configured with a timer, which may start or restart when the first packet of a PDU set arrives. When the timer expires and at least M packets of the current PDU set have been delivered, the transmitting device may discard the remaining packets of the current PDU set.

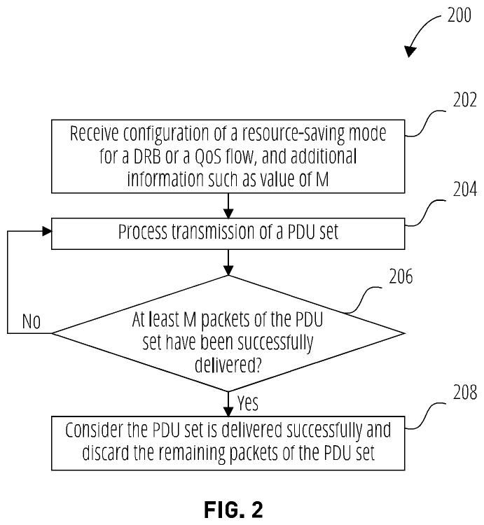

FIG. 2 is a flow diagram of a method 200 for a transmitting device in a resource-saving mode for transmission of a PDU set according to one embodiment. The transmitting device may comprise, for example, a UE or a base station. In a block 202, the method 200 includes receiving a configuration of the resource-saving mode for a DRB or a QoS flow. The configuration includes additional information such as value of M. In a block 204, the method 200 includes processing a transmission of the PDU set. The PDU set may be, for example, in a transmit buffer of the transmitting device.

In a decision block 206, the transmitting device queries whether at least M packets of the PDU set have been successfully delivered. If at least M packets of the PDU set have not yet been delivered, then the method 200 returns to the block 204 to continue processing the PDU set. When at least M packets of the PDU set have been delivered, as shown in block 208 of the method 200, the transmitting device considers the PDU set delivered successfully and discards the remaining packets of the PDU set. Although not shown in FIG. 2, the transmitting device may then process a next PDU set in its transmit buffer according to the configured resource-saving mode.

In certain embodiments of the method 200, the wireless device comprises a user equipment (UE), and receiving the configuration of the resource-saving mode comprises receiving the configuration from a base station for a data radio bearer (DRB) or a quality of service (QOS) flow for an uplink transmission.

In certain embodiments of the method 200, the wireless device comprises a base station, and receiving the configuration of the resource-saving mode comprises receiving the configuration from a core network for a data radio bearer (DRB) or a quality of service (QoS) flow for a downlink transmission.

In certain embodiments of the method 200, a minimum requirement for delivering the PDU set comprises at least M packets of the PDU set being successfully transmitted or submitted to a lower layer in a protocol stack for transmission, M is an integer, and the information to evaluate the minimum requirement for delivering the PDU set comprises a value of M.

In certain embodiments of the method 200, determining the information comprises receiving the value of M from a network node.

In certain embodiments of the method 200, determining the information comprises deriving, at the wireless device, the value of M based on a percentage of the PDU set to be successfully delivered.

In certain embodiments of the method 200, the value of M is different for different PDU sets.

In certain embodiments of the method 200, the value of M is zero, and processing the PDU set and discarding the unsent packets comprises discarding all packets of the PDU set.

In certain embodiments, the method 200 further comprises: incrementing a counter of the wireless device to determine how many delivered packets of the PDU set have been sent; and when the counter reaches the value of M, discarding the unsent packets of the PDU set and resetting the counter for a subsequent PDU set.

In certain embodiments, the method 200 further comprises: starting or restarting a timer of the wireless device when a first packet of the PDU set arrives in a transmit buffer of the wireless device; and when the timer expires and the at least M packets of the PDU set have been delivered, discarding the unsent packets of the PDU set.

In certain embodiments of the method 200, a minimum requirement for delivering the PDU set is selected from a group comprising an elapsed time since an arrival of a first packet of the PDU set has reached a first threshold, and a remaining time until an expiry of a PDU set delay budget (PSDB) is lower than a second threshold.

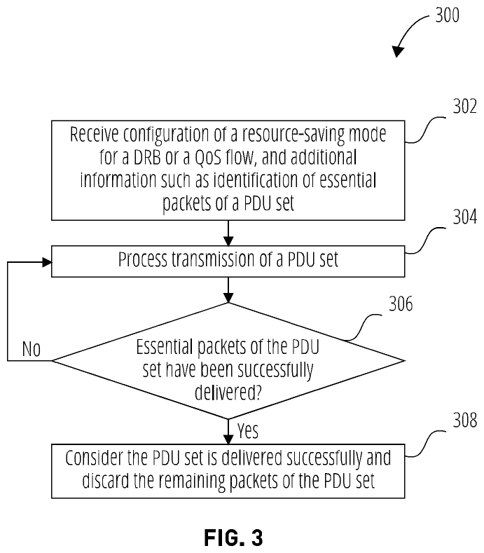

FIG. 3 is a flow diagram of a method 300 for a transmitting device in a resource-saving mode for transmission of a PDU set according to another embodiment. The transmitting device may comprise, for example, a UE or a base station. In a block 302, the method 300 includes receiving a configuration of the resource-saving mode for a DRB or a QoS flow. In this example, the configuration includes additional information such as identification of essential packets of the PDU set. In a block 304, the method 300 includes processing a transmission of the PDU set. The PDU set may be, for example, in a transmit buffer of the transmitting device.

In a decision block 306, the transmitting device queries whether the essential packets of the PDU set have been successfully delivered. If the essential packets of the PDU set have not yet been delivered, then the method 300 returns to the block 304 to continue processing the PDU set. When the essential packets of the PDU set have been delivered, as shown in block 308 of the method 300, the transmitting device considers the PDU set delivered successfully and discards the remaining packets of the PDU set. Although not shown in FIG. 3, the transmitting device may then process a next PDU set in its transmit buffer according to the configured resource-saving mode.

In certain embodiments of the method 300, the wireless device comprises a user equipment (UE), and receiving the configuration of the resource-saving mode comprises receiving the configuration from a base station for a data radio bearer (DRB) or a quality of service (QOS) flow for an uplink transmission.

In certain embodiments of the method 300, the wireless device comprises a base station, and receiving the configuration of the resource-saving mode comprises receiving the configuration from a core network for a data radio bearer (DRB) or a quality of service (QoS) flow for a downlink transmission.

In certain embodiments of the method 300, a minimum requirement for delivering the PDU set comprises essential packets from the PDU set being successfully transmitted or submitted to a lower layer in a protocol stack for transmission, and the information to evaluate the minimum requirement for delivering the PDU set comprises an identification of the essential packets.

In certain embodiments of the method 300, determining the information comprises receiving the identification of the essential packets from a network node.

In certain embodiments of the method 300, when a network node indicates that the PDU set includes only non-essential packets, processing the PDU set and discarding the unsent packets comprises discarding all packets of the PDU set.

In certain embodiments of the method 300, a minimum requirement for delivering the PDU set is selected from a group comprising an elapsed time since an arrival of a first packet of the PDU set has reached a first threshold, and a remaining time until an expiry of a PDU set delay budget (PSDB) is lower than a second threshold.

Embodiments contemplated herein include an apparatus comprising means to perform one or more elements of the method 200 or the method 300. This apparatus may be, for example, an apparatus of a UE (such as a wireless device 502 that is a UE, as described herein).

Embodiments contemplated herein include one or more non-transitory computer-readable media comprising instructions to cause an electronic device, upon execution of the instructions by one or more processors of the electronic device, to perform one or more elements of the method 200 or the method 300. This non-transitory computer-readable media may be, for example, a memory of a UE (such as a memory 506 of a wireless device 502 that is a UE, as described herein).

Embodiments contemplated herein include an apparatus comprising logic, modules, or circuitry to perform one or more elements of the method 200 or the method 300. This apparatus may be, for example, an apparatus of a UE (such as a wireless device 502 that is a UE, as described herein).

Embodiments contemplated herein include an apparatus comprising: one or more processors and one or more computer-readable media comprising instructions that, when executed by the one or more processors, cause the one or more processors to perform one or more elements of the method 200 or the method 300. This apparatus may be, for example, an apparatus of a UE (such as a wireless device 502 that is a UE, as described herein).

Embodiments contemplated herein include a signal as described in or related to one or more elements of the method 200 or the method 300.

Embodiments contemplated herein include a computer program or computer program product comprising instructions, wherein execution of the program by a processor is to cause the processor to carry out one or more elements of the method 200 or the method 300. The processor may be a processor of a UE (such as a processor(s) 504 of a wireless device 502 that is a UE, as described herein). These instructions may be, for example, located in the processor and/or on a memory of the UE (such as a memory 506 of a wireless device 502 that is a UE, as described herein).

Embodiments contemplated herein include an apparatus comprising means to perform one or more elements of the method 200 or the method 300. This apparatus may be, for example, an apparatus of a base station (such as a network device 518 that is a base station, as described herein).

Embodiments contemplated herein include one or more non-transitory computer-readable media comprising instructions to cause an electronic device, upon execution of the instructions by one or more processors of the electronic device, to perform one or more elements of the method 200 or the method 300. This non-transitory computer-readable media may be, for example, a memory of a base station (such as a memory 522 of a network device 518 that is a base station, as described herein).

Embodiments contemplated herein include an apparatus comprising logic, modules, or circuitry to perform one or more elements of the method 200 or the method 300. This apparatus may be, for example, an apparatus of a base station (such as a network device 518 that is a base station, as described herein).

Embodiments contemplated herein include an apparatus comprising: one or more processors and one or more computer-readable media comprising instructions that, when executed by the one or more processors, cause the one or more processors to perform one or more elements of the method 200 or the method 300. This apparatus may be, for example, an apparatus of a base station (such as a network device 518 that is a base station, as described herein).

Embodiments contemplated herein include a signal as described in or related to one or more elements of the method 200 or the method 300.

Embodiments contemplated herein include a computer program or computer program product comprising instructions, wherein execution of the program by a processing element is to cause the processing element to carry out one or more elements of the method 200 or the method 300. The processor may be a processor of a base station (such as a processor(s) 520 of a network device 518 that is a base station, as described herein). These instructions may be, for example, located in the processor and/or on a memory of the base station (such as a memory 522 of a network device 518 that is a base station, as described herein).

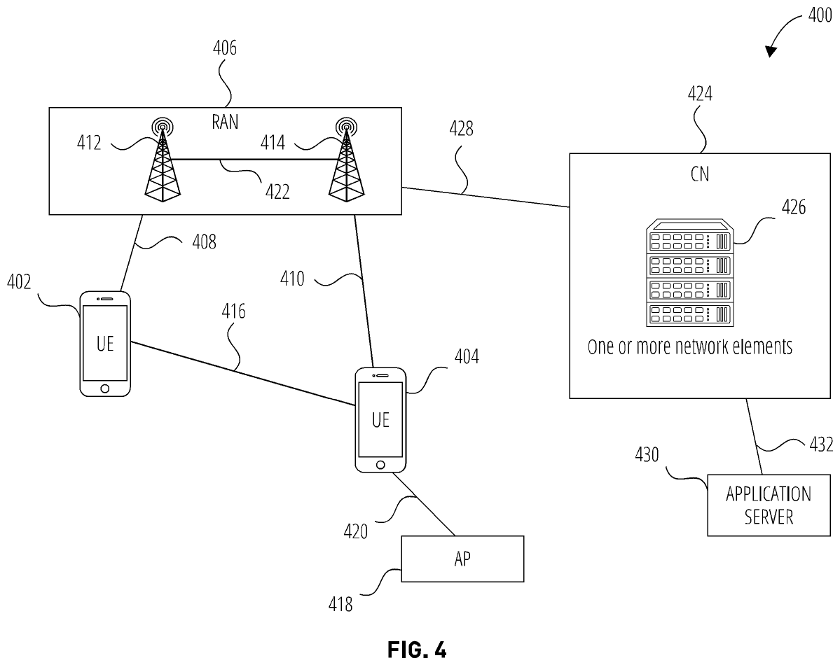

FIG. 4 illustrates an example architecture of a wireless communication system 400, according to embodiments disclosed herein. The following description is provided for an example wireless communication system 400 that operates in conjunction with the LTE system standards and/or 5G or NR system standards as provided by 3GPP technical specifications.

As shown by FIG. 4, the wireless communication system 400 includes UE 402 and UE 404 (although any number of UEs may be used). In this example, the UE 402 and the UE 404 are illustrated as smartphones (e.g., handheld touchscreen mobile computing devices connectable to one or more cellular networks), but may also comprise any mobile or non-mobile computing device configured for wireless communication.

The UE 402 and UE 404 may be configured to communicatively couple with a RAN 406. In embodiments, the RAN 406 may be NG-RAN, E-UTRAN, etc. The UE 402 and UE 404 utilize connections (or channels) (shown as connection 408 and connection 410, respectively) with the RAN 406, each of which comprises a physical communications interface. The RAN 406 can include one or more base stations (such as base station 412 and base station 414) that enable the connection 408 and connection 410.

In this example, the connection 408 and connection 410 are air interfaces to enable such communicative coupling, and may be consistent with RAT(s) used by the RAN 406, such as, for example, an LTE and/or NR.

In some embodiments, the UE 402 and UE 404 may also directly exchange communication data via a sidelink interface 416. The UE 404 is shown to be configured to access an access point (shown as AP 418) via connection 420. By way of example, the connection 420 can comprise a local wireless connection, such as a connection consistent with any IEEE 802.11 protocol, wherein the AP 418 may comprise a Wi-Fi® router. In this example, the AP 418 may be connected to another network (for example, the Internet) without going through a CN 424.

In embodiments, the UE 402 and UE 404 can be configured to communicate using orthogonal frequency division multiplexing (OFDM) communication signals with each other or with the base station 412 and/or the base station 414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 412 or base station 414 may be implemented as one or more software entities running on server computers as part of a virtual network. In addition, or in other embodiments, the base station 412 or base station 414 may be configured to communicate with one another via interface 422. In embodiments where the wireless communication system 400 is an LTE system (e.g., when the CN 424 is an EPC), the interface 422 may be an X2 interface. The X2 interface may be defined between two or more base stations (e.g., two or more eNBs and the like) that connect to an EPC, and/or between two eNBs connecting to the EPC. In embodiments where the wireless communication system 400 is an NR system (e.g., when CN 424 is a 5GC), the interface 422 may be an Xn interface. The Xn interface is defined between two or more base stations (e.g., two or more gNBs and the like) that connect to 5GC, between a base station 412 (e.g., a gNB) connecting to 5GC and an eNB, and/or between two eNBs connecting to 5GC (e.g., CN 424).

The RAN 406 is shown to be communicatively coupled to the CN 424. The CN 424 may comprise one or more network elements 426, which are configured to offer various data and telecommunications services to customers/subscribers (e.g., users of UE 402 and UE 404) who are connected to the CN 424 via the RAN 406. The components of the CN 424 may be implemented in one physical device or separate physical devices including components to read and execute instructions from a machine-readable or computer-readable medium (e.g., a non-transitory machine-readable storage medium).

In embodiments, the CN 424 may be an EPC, and the RAN 406 may be connected with the CN 424 via an S1 interface 428. In embodiments, the SI interface 428 may be split into two parts, an S1 user plane (S1-U) interface, which carries traffic data between the base station 412 or base station 414 and a serving gateway (S-GW), and the S1-MME interface, which is a signaling interface between the base station 412 or base station 414 and mobility management entities (MMEs).

In embodiments, the CN 424 may be a 5GC, and the RAN 406 may be connected with the CN 424 via an NG interface 428. In embodiments, the NG interface 428 may be split into two parts, an NG user plane (NG-U) interface, which carries traffic data between the base station 412 or base station 414 and a UPF, and the SI control plane (NG-C) interface, which is a signaling interface between the base station 412 or base station 414 and access and mobility management functions (AMFs).

Generally, an application server 430 may be an element offering applications that use internet protocol (IP) bearer resources with the CN 424 (e.g., packet switched data services). The application server 430 can also be configured to support one or more communication services (e.g., VOIP sessions, group communication sessions, etc.) for the UE 402 and UE 404 via the CN 424. The application server 430 may communicate with the CN 424 through an IP communications interface 432.

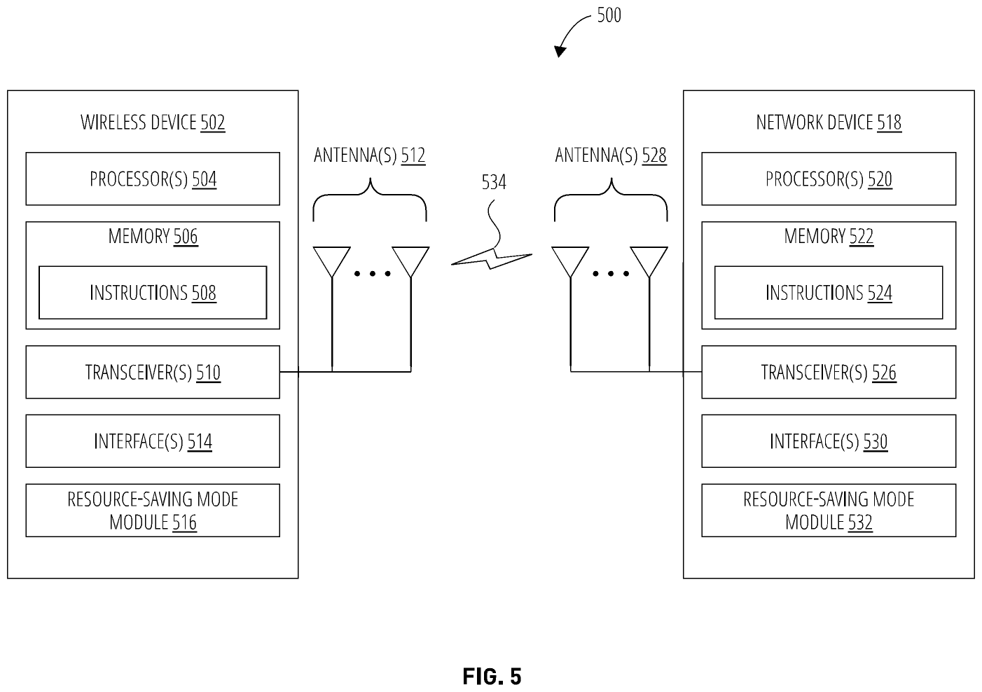

FIG. 5 illustrates a system 500 for performing signaling 534 between a wireless device 502 and a network device 518, according to embodiments disclosed herein. The system 500 may be a portion of a wireless communications system as herein described. The wireless device 502 may be, for example, a UE of a wireless communication system. The network device 518 may be, for example, a base station (e.g., an eNB or a gNB) of a wireless communication system.

The wireless device 502 may include one or more processor(s) 504. The processor(s) 504 may execute instructions such that various operations of the wireless device 502 are performed, as described herein. The processor(s) 504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 502 may include a memory 506. The memory 506 may be a non-transitory computer-readable storage medium that stores instructions 508 (which may include, for example, the instructions being executed by the processor(s) 504). The instructions 508 may also be referred to as program code or a computer program. The memory 506 may also store data used by, and results computed by, the processor(s) 504. In certain embodiments, the memory 506 may include a buffer or transmit buffer to store packets of a PDU set.

The wireless device 502 may include one or more transceiver(s) 510 that may include radio frequency (RF) transmitter and/or receiver circuitry that use the antenna(s) 512 of the wireless device 502 to facilitate signaling (e.g., the signaling 534) to and/or from the wireless device 502 with other devices (e.g., the network device 518) according to corresponding RATs.

The wireless device 502 may include one or more antenna(s) 512 (e.g., one, two, four, or more). For embodiments with multiple antenna(s) 512, the wireless device 502 may leverage the spatial diversity of such multiple antenna(s) 512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 502 may be accomplished according to precoding (or digital beamforming) that is applied at the wireless device 502 that multiplexes the data streams across the antenna(s) 512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 502 may implement analog beamforming techniques, whereby phases of the signals sent by the antenna(s) 512 are relatively adjusted such that the (joint) transmission of the antenna(s) 512 can be directed (this is sometimes referred to as beam steering).

The wireless device 502 may include one or more interface(s) 514. The interface(s) 514 may be used to provide input to or output from the wireless device 502. For example, a wireless device 502 that is a UE may include interface(s) 514 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 510/antenna(s) 512 already described) that allow for communication between the UE and other devices and may operate according to known protocols (e.g., Wi-Fi®, Bluetooth®, and the like).

The wireless device 502 may comprise an XR device, which may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook).

The wireless device 502 may include a resource-saving mode module 516. The resource-saving mode module 516 may be implemented via hardware, software, or combinations thereof. For example, the resource-saving mode module 516 may be implemented as a processor, circuit, and/or instructions 508 stored in the memory 506 and executed by the processor(s) 504. In some examples, the resource-saving mode module 516 may be integrated within the processor(s) 504 and/or the transceiver(s) 510. For example, the resource-saving mode module 516 may be implemented by a combination of software components (e.g., executed by a DSP or a general processor) and hardware components (e.g., logic gates and circuitry) within the processor(s) 504 or the transceiver(s) 510.

The resource-saving mode module 516 may be used for various aspects of the present disclosure, for example, aspects of FIG. 2 and FIG. 3. In certain embodiments, the resource-saving mode module 516 includes a counter or a timer, as discussed herein.

The network device 518 may include one or more processor(s) 520. The processor(s) 520 may execute instructions such that various operations of the network device 518 are performed, as described herein. The processor(s) 520 may include one or more baseband processors implemented using, for example, a CPU, a DSP, an ASIC, a controller, an FPGA device, another hardware device, a firmware device, or any combination thereof configured to perform the operations described herein.

The network device 518 may include a memory 522. The memory 522 may be a non-transitory computer-readable storage medium that stores instructions 524 (which may include, for example, the instructions being executed by the processor(s) 520). The instructions 524 may also be referred to as program code or a computer program. The memory 522 may also store data used by, and results computed by, the processor(s) 520. In certain embodiments, the memory 522 includes a buffer to store PDU sets.

The network device 518 may include one or more transceiver(s) 526 that may include RF transmitter and/or receiver circuitry that use the antenna(s) 528 of the network device 518 to facilitate signaling (e.g., the signaling 534) to and/or from the network device 518 with other devices (e.g., the wireless device 502) according to corresponding RATs.

The network device 518 may include one or more antenna(s) 528 (e.g., one, two, four, or more). In embodiments having multiple antenna(s) 528, the network device 518 may perform MIMO, digital beamforming, analog beamforming, beam steering, etc., as has been described.

The network device 518 may include one or more interface(s) 530. The interface(s) 530 may be used to provide input to or output from the network device 518. For example, a network device 518 that is a base station may include interface(s) 530 made up of transmitters, receivers, and other circuitry (e.g., other than the transceiver(s) 526/antenna(s) 528 already described) that enables the base station to communicate with other equipment in a core network, and/or that enables the base station to communicate with external networks, computers, databases, and the like for purposes of operations, administration, and maintenance of the base station or other equipment operably connected thereto.

The network device 518 may include a resource-saving mode module 532. The resource-saving mode module 532 may be implemented via hardware, software, or combinations thereof. For example, the resource-saving mode module 532 may be implemented as a processor, circuit, and/or instructions 524 stored in the memory 522 and executed by the processor(s) 520. In some examples, the resource-saving mode module 532 may be integrated within the processor(s) 520 and/or the transceiver(s) 526. For example, the resource-saving mode module 532 may be implemented by a combination of software components (e.g., executed by a DSP or a general processor) and hardware components (e.g., logic gates and circuitry) within the processor(s) 520 or the transceiver(s) 526.

The resource-saving mode module 532 may be used for various aspects of the present disclosure, for example, aspects of FIG. 2 and FIG. 3. In certain embodiments, the resource-saving mode module 532 includes a counter or a timer, as discussed herein.

### Example System Architecture

In certain embodiments, 5G System (5GS) architecture supports data connectivity and services enabling deployments to use techniques such as Network Function Virtualization and Software Defined Networking. The 5G System architecture may leverage service-based interactions between Control Plane Network Functions. Separating User Plane functions from the Control Plane functions allows independent scalability, evolution, and flexible deployments (e.g., centralized location or distributed (remote) location). Modularized function design allows for function re-use and may enable flexible and efficient network slicing. A Network Function (NF) and its Network Function Services may interact with another NF and its Network Function Services directly or indirectly via a Service Communication Proxy. Another intermediate function may help route Control Plane messages. The architecture minimizes dependencies between the access network (AN) and the core network (CN). The architecture may include a converged core network with a common AN-CN interface that integrates different Access Types (e.g., 3GPP access and non-3GPP access). The architecture may also support a unified authentication framework, stateless NFs where the compute resource is decoupled from the storage resource, capability exposure, concurrent access to local and centralized services (to support low latency services and access to local data networks, User Plane functions can be deployed close to the AN), and/or roaming with both Home routed traffic as well as Local breakout traffic in the visited Public Land Mobile Network (PLMN).

The 5G architecture may be defined as service-based and the interaction between network functions may include a service-based representation, where network functions (e.g., Access and Mobility Management Function (AMF)) within the Control Plane enable other authorized network functions to access their services. The service-based representation may also include point-to-point reference points. A reference point representation may also be used to show the interactions between the NF services in the network functions described by point-to-point reference point (e.g., N11) between any two network functions (e.g., AMF and Session Management Function (SMF)).

FIG. 6 illustrates an example service based architecture 600 in 5GS according to one embodiment. The service based architecture 600 includes NFs such as a Network Slice Selection Function (show as NSSF 608), a Network Exposure Function (shown as NEF 610), a Network Repository Function (shown as NRF 614), a Policy Control Function (shown as PCF 612), a Unified Data Management Function (shown as UDM 626), an Authentication Server Function (shown as AUSF 618), an AMF 620, an SMF 622, for communication with a UE 616, a (R) AN 606, a User Plane Function (shown as UPF 602), and a Data Network (shown as DN 604). The NFs and NF services can communicate directly, referred to as Direct Communication, or indirectly via a Service Communication Proxy (shown as SCP 624), referred to as Indirect Communication. FIG. 6 also shows corresponding service-based interfaces including Nutm, Naf, Nudm, Npcf, Nsmf, Nnrf, Namf, Nnef, Nnssf, and Nausf, as well as reference points N1, N2, N3, N4, and N6. A few example functions provided by the NFs shown in FIG. 6 are described below.

The UPF 602 may act as an anchor point for intra-RAT and inter-RAT mobility, an external PDU session point of interconnect to the DN 604, and a branching point to support multi-homed PDU session. The UPF 602 may also perform packet routing and forwarding, perform packet inspection, enforce user plane part of policy rules, lawfully intercept packets, perform traffic usage reporting, perform QoS handling for user plane (e.g., packet filtering, gating, uplink/downlink rate enforcement), perform Uplink Traffic verification (e.g., Service Data Flow (SDF) to QoS flow mapping), perform transport level packet marking in the uplink and downlink, and perform downlink packet buffering and downlink data notification triggering. The UPF 602 may include an uplink classifier to support routing traffic flows to a data network.

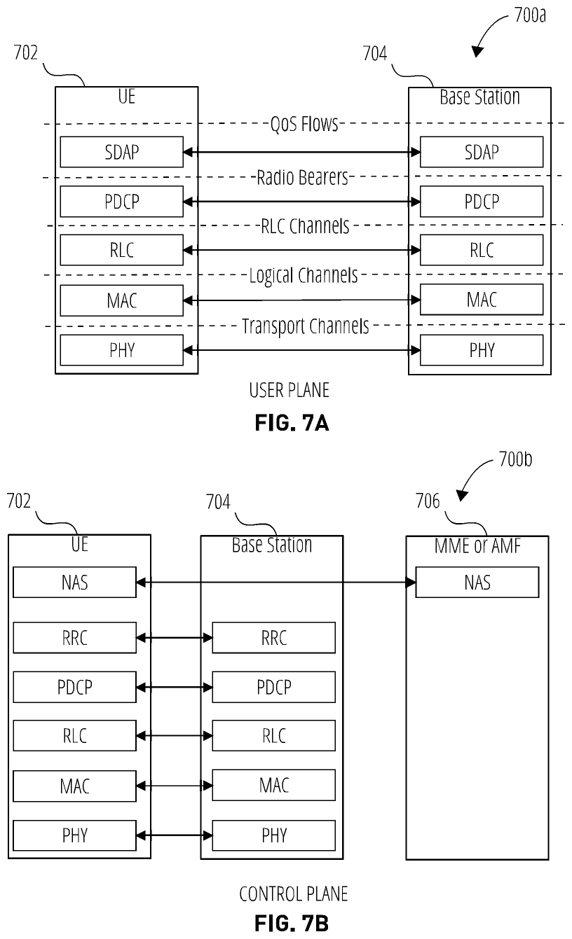

FIG. 7A and FIG. 7B illustrate examples of protocol stacks in a 3GPP based wireless communication system. As used herein, a layer of a protocol stack may also be referred to as an entity (or simply by the name of the layer). For example, a physical (PHY) layer may be referred to as a PHY entity (or simply as a PHY), a media access control (MAC) layer may be referred to as a MAC entity (or simply as a MAC), a radio link control (RLC) layer may be referred to as an RLC entity (or simply as an RLC), a packet data convergence protocol (PDCP) layer may be referred to as a PDCP entity (or simply as a PDCP), a service data adaptation protocol (SDAP) layer may be referred to as an SDAP entity (or simply an SDAP), and a radio resource control (RRC) layer may be referred to as an RRC entity (or simply as an RRC).

FIG. 7A illustrates an example of a user plane protocol stack 700a for communication between a UE 702 and a base station 704 according to one embodiment. The user plane refers to a path through which data generated in an application layer (e.g., voice data, video data, or internet packet data) are transported. The user plane protocol stack 700a may be divided into a Layer 1 (L1) protocol and a Layer 2 (L2) protocol. In NR systems, the L1 protocol includes the PHY and the L2 protocol includes the MAC, RLC, PDCP, and SDAP.

The PHY may transmit or receive information used by the MAC over one or more air interfaces (i.e., physical channels and signals). The PHY offers to the MAC transport channels, the MAC offers to the RLC logical channels, the RLC offers to the PDCP RLC channels, the PDCP offers to the SDAP radio bearers, and the SDAP offers to 5GC QoS flows.

In NR systems, example services and functions of SDAP include mapping between a QoS flow and a data radio bearer and marking QoS flow ID (QFI) in both DL and UL packets. A single SDAP entity may be configured for each individual protocol data unit (PDU) session.

In NR systems, example services and functions of the PDCP for the user plane include sequence numbering, header compression and decompression, transfer of user data, reordering and duplicate detection, in-order delivery, PDCP PDU routing (in case of split bearers), retransmission of PDCP service data units (SDUs), ciphering/deciphering and integrity protection, PDCP SDU discard, PDCP re-establishment and data recovery for RLC AM, PDCP status reporting for RLC acknowledgement mode (AM), duplication of PDCP PDUs, and duplicate discard indication to lower layers.

In NR systems, the RLC supports three transmission modes: transparent mode (TM); unacknowledged mode (UM); and acknowledged mode (AM). The RLC configuration is per logical channel with no dependency on numerologies and/or transmission durations. Example services and functions of the RLC depend on the transmission mode and include transfer of upper layer PDUs, sequence numbering independent of the one in PDCP (UM and AM), error correction through automatic repeat request (ARQ) (AM only), segmentation (AM and UM) and re-segmentation (AM only) of RLC SDUs, reassembly of SDUs (AM and UM), duplicate detection (AM only), RLC SDU discard (AM and UM), RLC re-establishment, and protocol error detection (AM only).

In NR systems, example services and functions of the MAC include mapping between logical channels and transport channels, multiplexing/demultiplexing of MAC SDUs belonging to one or different logical channels into/from transport blocks (TBs) delivered to/from the physical layer on transport channels, scheduling information reporting, error correction through hybrid ARQ (HARQ) (one HARQ entity per cell in case of carrier aggregation (CA)), priority handling between UEs by dynamic scheduling, priority handling between logical channels of one UE by logical channel prioritization, and padding. A single MAC entity may support multiple numerologies, transmission timings, and cells. Mapping restrictions in logical channel prioritization control which of the numerology(ies), cell(s), and transmission timing(s) a logical channel can use. To accommodate different kinds of data transfer services offered by the MAC, multiple types of logical channels are defined. Each logical channel type is defined by what type of information is transferred. The MAC PDU arrives to the PHY layer in the form of a transport block.

FIG. 7B illustrates an example of a control plane protocol stack 700b for communication between the UE 702, the base station 704, and a core network 706 (i.e., a mobility management entity (MME) in LTE or an access and mobility management function (AMF) in NR). The control plane refers to a path through which control messages used to manage calls by a UE and a network are transported.

The control plane protocol stack 700b includes PHY, MAC, RLC, PDCP, and RRC layers in an access stratum (AS). The control plane protocol stack 700b also includes a non-access stratum (NAS) comprising a set of protocols to convey non-radio signaling between the UE 702 and the core network 706. The NAS performs functions such as authentication, mobility management, and security control.

As discussed above, the PHY may transmit or receive information used by the MAC over one or more air interfaces. The PHY layer may further perform link adaptation or adaptive modulation and coding (AMC), power control, cell search (e.g., for initial synchronization and handover purposes), and other measurements used by higher layers, such as the RRC. The PHY may further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

In NR systems, example services and functions of the RRC include broadcast of system information related to AS and NAS, paging initiated by 5GC or a RAN, establishment and maintenance or release of an RRC connection between the UE and the RAN, security functions including key management, establishment/configuration/maintenance/release of signaling radio bearers (SRBs) and data radio bearers (DRBs), mobility functions (including handover and context transfer, UE cell selection and reselection, and inter-RAT mobility, QoS management functions, UE measurement reporting and control of the reporting, detection of and recovery from radio link failure, and NAS message transfer.

The example services and functions of the PDCP for the control plane include sequence numbering, ciphering/deciphering and integrity protection, transfer of control plane data, reordering and duplicate detection, in-order delivery, duplication of PDCP PDUs, and duplicate discard indication to lower layers.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A wireless device configured to transmit a protocol data unit (PDU) set, the wireless device comprising:
a processor; and
a memory storing instructions that, when executed by the processor, configure the wireless device to:
receive a configuration of a resource-saving mode in which the wireless device is allowed to discard, when a minimum requirement for delivering the PDU set is satisfied, one or more packets of the PDU set;
determine information to evaluate the minimum requirement for delivering the PDU set;
process the PDU set for transmission; and
when the minimum requirement for delivering the PDU set is satisfied, based on the information, determine that the PDU set is successfully delivered and discard any unsent packets of the PDU set.

2. The wireless device of claim 1, wherein the wireless device comprises a user equipment (UE), and wherein to receive the configuration of the resource-saving mode comprises to receive the configuration from a base station for a data radio bearer (DRB) or a quality of service (QOS) flow for an uplink transmission.

3. The wireless device of claim 1, wherein the wireless device comprises a base station, and wherein to receive the configuration of the resource-saving mode comprises to receive the configuration from a core network for a data radio bearer (DRB) or a quality of service (QOS) flow for a downlink transmission.

4. The wireless device of claim 1, wherein the minimum requirement for delivering the PDU set comprises at least M packets of the PDU set being successfully transmitted or submitted to a lower layer in a protocol stack for transmission, wherein M is an integer, and wherein the information to evaluate the minimum requirement for delivering the PDU set comprises a value of M.

5. The wireless device of claim 4, wherein to determine the information comprises to receive the value of M from a network node.

6. The wireless device of claim 4, wherein to determine the information comprises to derive, at the wireless device, the value of M based on a percentage of the PDU set to be successfully delivered.

7. The wireless device of claim 4, wherein the value of M is different for different PDU sets.

8. The wireless device of claim 4, wherein the value of M is zero, and wherein to process the PDU set and discard the unsent packets comprises to discard all packets of the PDU set.

9. The wireless device of claim 4, wherein the wireless device further comprises a counter, and wherein the instructions further configure the wireless device to:
increment the counter to determine how many delivered packets of the PDU set have been sent; and
when the counter reaches the value of M, discard the unsent packets of the PDU set and reset the counter for a subsequent PDU set.

10. The wireless device of claim 4, wherein the wireless device further comprises a timer, and wherein the instructions further configure the apparatus to:
start or restart the timer when a first packet of the PDU set arrives in a transmit buffer of the wireless device; and
when the timer expires and the at least M packets of the PDU set have been delivered, discard the unsent packets of the PDU set.

11. The wireless device of claim 1, wherein the minimum requirement for delivering the PDU set comprises essential packets from the PDU set being successfully transmitted or submitted to a lower layer in a protocol stack for transmission, and wherein the information to evaluate the minimum requirement for delivering the PDU set comprises an identification of the essential packets.

12. The wireless device of claim 11, wherein to determine the information comprises to receive the identification of the essential packets from a network node.

13. The wireless device of claim 11, wherein when a network node indicates that the PDU set includes only non-essential packets, to process the PDU set and to discard the unsent packets comprises to discard all packets of the PDU set.

14. The wireless device of claim 1, wherein the minimum requirement for delivering the PDU set is selected from a group comprising an elapsed time since an arrival of a first packet of the PDU set has reached a first threshold, and a remaining time until an expiry of a PDU set delay budget (PSDB) is lower than a second threshold.

15. A method for a wireless device to transmit a protocol data unit (PDU) set, the method comprising:
receiving a configuration of a resource-saving mode in which the wireless device is allowed to discard, when a minimum requirement for delivering the PDU set is satisfied, one or more packets of the PDU set;
determining information to evaluate the minimum requirement for delivering the PDU set;
processing the PDU set for transmission; and
when the minimum requirement for delivering the PDU set is satisfied, based on the information, determining that the PDU set is successfully delivered and discarding any unsent packets of the PDU set.

16. The method of claim 15, wherein the wireless device comprises a user equipment (UE), and wherein receiving the configuration of the resource-saving mode comprises receiving the configuration from a base station for a data radio bearer (DRB) or a quality of service (QOS) flow for an uplink transmission.

17. The method of claim 15, wherein the wireless device comprises a base station, and wherein receiving the configuration of the resource-saving mode comprises receiving the configuration from a core network for a data radio bearer (DRB) or a quality of service (QoS) flow for a downlink transmission.

18. The method of claim 15, wherein the minimum requirement for delivering the PDU set comprises at least M packets of the PDU set being successfully transmitted or submitted to a lower layer in a protocol stack for transmission, wherein M is an integer, and wherein the information to evaluate the minimum requirement for delivering the PDU set comprises a value of M.

19. The method of claim 18, wherein determining the information comprises receiving the value of M from a network node.

20. The method of claim 18, wherein determining the information comprises deriving, at the wireless device, the value of M based on a percentage of the PDU set to be successfully delivered.

21-30. (canceled)
